(19) United States
(12) Patent Application Publication
(10) Pub. No.: US 2015/0111674 A1
(43) Pub. Date: Apr. 23, 2015

(54) CVT DRIVE CLUTCH

(71) Applicant: THE GATES CORPORATION, Denver, CO (US)

(72) Inventors: Jing Yuan, Rochester Hills, MI (US); Gerard Karpik, Eveleth, MN (US); Kanchan Kumar Singh, Kancheepuram District (IN)

(73) Assignee: THE GATES CORPORATION, DENVER, CO (US)

(21) Appl. No.: 14/056,444

(22) Filed: Oct. 17, 2013

(51) Int. Cl. F16H 9/12; F16H 55/56

(52) U.S. Cl. CPC F16H 9/12; F16H 55/563
USPC 474/14

(57) ABSTRACT

A CVT drive system comprising a sheave axially moveable along a first shaft and having a radially extending surface, a sheave fixed to the first shaft, the fixed sheave cooperatively disposed with the moveable sheave to engage a belt therebetween, the first shaft engagable with an engine, a back plate attached to the first shaft having a radial surface, the back plate engaged with the moveable sheave for locked rotation while allowing a relative axial movement, an inertia member radially moveable upon the radially extending surface and the radial surface upon rotation of the moveable sheave, the inertia member is temporarily disengagable from the radial surface and from the radially extending surface, a first spring resisting axial movement of the moveable sheave toward the fixed sheave along the first shaft, and a sleeve member disposed between the moveable sheave and the fixed sheave, the sleeve member rotatable with the belt.

### FIELD OF THE INVENTION

The invention relates to a CVT clutch comprising an inertia member disposed between a back plate and a moveable sheave, the inertia member radially moveable upon a radially extending surface upon rotation of the moveable sheave.

### BACKGROUND OF THE INVENTION

A typical CVT transmission is made up of a split sheave primary drive clutch connected to the output of the vehicle engine (often the crankshaft) and split sheave secondary driven clutch connected (often through additional drive train linkages) to the vehicle axle. An endless, flexible, generally V-shaped drive belt is disposed about the clutches. Each of the clutches has a pair of complementary sheaves, one of the sheaves being movable with respect to the other. The effective gear ratio of the transmission is determined by the positions of the movable sheaves in each of the clutches.

The primary drive clutch has its sheaves normally biased apart (e.g., by a compression coil spring), so that when the engine is at idle speeds, the drive belt does not effectively engage the sheaves, thereby conveying essentially no driving force to the secondary driven clutch. The secondary driven clutch has its sheaves normally biased together (e.g., by a compression or torsion spring working in combination with a helix-type cam, as described below, so that when the engine is at idle speeds the drive belt rides near the outer perimeter of the driven clutch sheaves.

The axial spacing of the sheaves in the primary drive clutch usually is controlled by centrifugal flyweights. Centrifugal flyweights are operably connected to the engine shaft so that they rotate along with the engine shaft. As the engine shaft rotates faster (in response to increased engine speed) the flyweights also rotate faster and pivot outwardly, urging the movable sheave toward the stationary sheave. The more radially outwardly the flyweights move the more the moveable sheave is axially moved toward the stationary sheave. This pinches the drive belt, causing the belt to begin rotating with the drive clutch, the belt in turn causing the driven clutch to begin to rotate.

Further movement of the device clutch's movable sheave toward the stationary sheave forces the belt to climb radially outward on the drive clutch sheaves, increasing the effective diameter of the drive belt path around the drive clutch. Thus, the spacing of the sheaves in the drive clutch changes based primarily on engine speed. The drive clutch therefore can be said to be speed sensitive, and is also called the speed governor.

As the sheaves of the drive clutch pinch the drive belt and force the belt to move radially outward on the drive clutch sheaves, the belt is pulled radially inward between the sheaves of the driven clutch, decreasing the effective diameter of the drive belt path around the driven clutch. This movement of the belt on the drive and driven clutches smoothly changes the effective gear ratio of the transmission in variable increments. Tuning the engagement speed is accomplished by a combination of the pre-load of the compression spring and the mass. The device provides a smooth transition for the vehicle from a full stop. The disadvantage is the extra cost and added on mass.

Representative of the art is U.S. Pat. No. 5,460,575 which discloses a drive clutch assembly having a fixed sheave and a movable sheave rotatable with the drive shaft of an engine comprising a variable rate biasing or resistance system for urging a movable sheave toward a retracted position, the biasing system initially applies a first predetermined resistance to the movable sheave as it moves toward the fixed sheave and applies a second predetermined resistance to the movable sheave when the movable sheave reaches a predetermined axial position.

What is needed is a CVT clutch comprising an inertia member disposed between a back plate and a moveable sheave, the inertia member radially moveable upon a radially extending surface upon rotation of the moveable sheave. The present invention meets this need.

### SUMMARY OF THE INVENTION

An aspect of the invention is to provide a CVT clutch comprising an inertia member disposed between a back plate and a moveable sheave, the inertia member radially moveable upon a radially extending surface upon rotation of the moveable sheave.

Other aspects of the invention will be pointed out or made obvious by the following description of the invention and the accompanying drawings.

The invention comprises a CVT drive system comprising a moveable sheave axially moveable along a first shaft and having a radially extending surface, a fixed sheave fixed to the first shaft, the fixed sheave cooperatively disposed with the moveable sheave to engage a belt therebetween, the first shaft engagable with an engine output, a back plate attached to the first shaft and having a radial surface, the back plate engaged with the moveable sheave for a locked rotation while allowing a relative axial movement, an inertia member radially moveable upon the radially extending surface and the radial surface upon rotation of the moveable sheave, the inertia member is temporarily disengagable from the radial surface and from the radially extending surface, a first spring resisting axial movement of the moveable sheave toward the fixed sheave along the first shaft, and a sleeve member disposed between the moveable sheave and the fixed sheave, the sleeve member rotatable with the belt.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is an exploded view of the driver mechanism.

FIG. 2 is an exploded view of the driven mechanism.

FIG. 3 is a cross-section detail of the driver mechanism.

FIG. 4 is a cross section of the driver mechanism in the open position.

FIG. 5 is a cross section of the driver mechanism in the closed position.

FIG. 6 is a rear view of the driver mechanism.

FIG. 7 is a cross section of the driven mechanism.

FIG. 8 is a chart of the shift curve.

FIG. 9 is a chart of the shift curve at WOT.

FIG. 10 is a fuel efficiency chart.

FIG. 11 is a chart which compares constant speed fuel economy for an inventive CVT system and a prior art CVT with centrifugal clutch.

FIG. 12 is a cross section of the moveable sheave.

FIG. 13 is a chart depicting belt slip.

### DETAILED DESCRIPTION OF THE PREFERRED EMBODIMENT

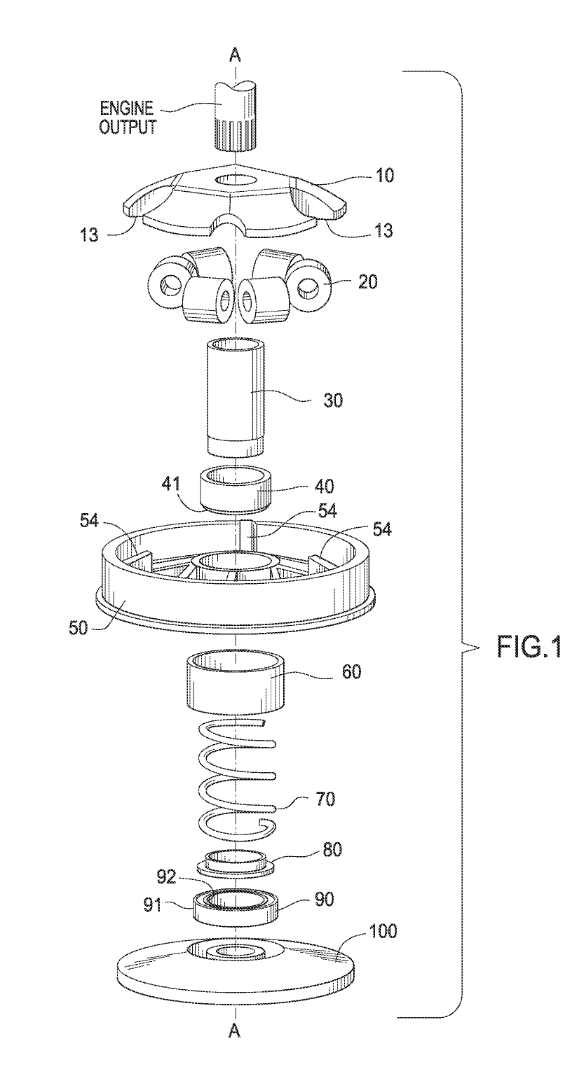

FIG. 1 is an exploded view of the driver mechanism. The driver mechanism or clutch as shown in FIG. 1 comprises a stationary back plate 10. Back plate 10 is fixed to and rotates with cylindrical shaft 30. Back plate is fixedly attached to an engine output shaft (not shown). Inertia members 20 are captured between back plate 10 and moveable sheave 50. Members 20 are moveable radially inward or outward in response to the rotational speed of the driver clutch. Members 20 are shown as round in cross section but may have any suitable shape. Moveable sheave 50 is axially moveable along the axis of rotation of shaft 30. Each radial member 54 engages a cooperating slot 13 whereby moveable sheave 50 will rotate in locked fashion with back plate 10 while allowing a relative axial movement.

Sheave 50 has a sliding engagement with bush 40 and shaft 30. Step 41 at an outside diameter of bush 40 forms a spring seat. Spring 70 is disposed between spring seat 41 and spring cup 80. Spring 70 resists movement of moveable sheave 50 toward sheave 100. Sleeve 60 engages the bearing 90 outer raceway 91 to support the belt when the belt (not shown) is in the radially inward position. Bearing 90 inner raceway 92 engages and rotates with shaft 30. Sleeve 60 covers spring 70 to prevent engagement of the belt with spring 70. Further, spring cup 80 contacts and rotates with the inner raceway 92 of bearing 90. Spring cup 80 together with spring seat 41 locate spring 70 within the mechanism. Sheave 100 is fixedly attached to an engine output shaft (not shown) by a splined joint.

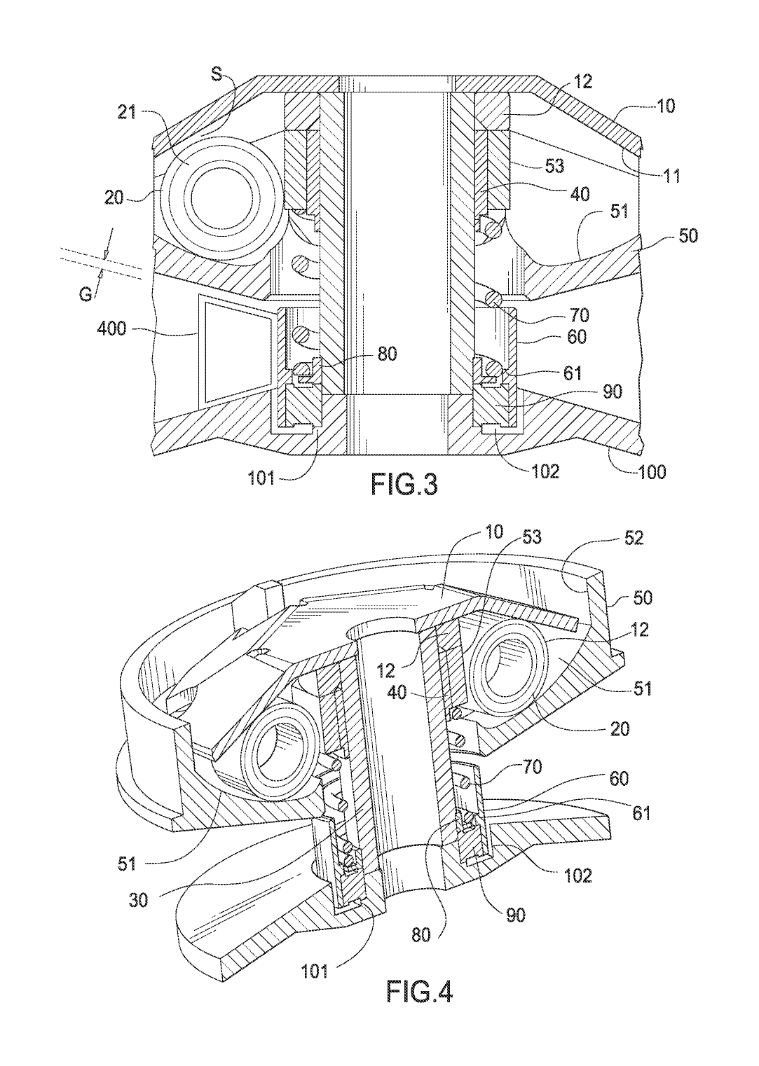

The system may use a plurality of inertia members 20. The instant embodiment comprises six members 20 by way of example and not of limitation. Each member 20 comprises a mass. The mass of each member determines the radial force each develops as a function of the rotational speed of the clutch. The amount of mass used in each member is adjustable by adding an insert 21 to a member or members, see FIG. 3. By way of example, the mass of each member 20 is 14 grams in this embodiment.

For a given mass (m) and number of members 20 one may determine the total force which will be exerted against the force of spring 70 as the clutch rotates. This in part determines the operational characteristics of the system such as at which speeds radially outward movement of the members 20 takes place overcoming the spring force and thereby causing axial movement of movable sheave 50 toward sheave 100 against the spring force 70. In other words: F=mrω², the total centrifugal force (F), which acts in radial outward direction is balanced by the reaction forces from both the back place 10 and from the sheave 50.

Both back plate 10 and sheave 50 have surfaces (51,11) which are inclined to a normal extending radially from the shaft. The reaction force between each member 20 and the moveable sheave 50 has a component that is projected in the axial direction along the axis of rotation A-A. The axial force exerted on the moveable sheave 50 is cumulative depending upon the number of members 20 used in the clutch and the profile of the surface 51 and surface 11, see FIG. 12 and FIG. 3.

Members 20 are disposed in a radially inward position (small radius from axis of rotation A-A) during low rotational speed conditions. This represents the position of greatest separation between the movable sheave 50 and stationary sheave 100. As the rotational speed increases the members move radially outward and moveable sheave 50 moves toward sheave 100.

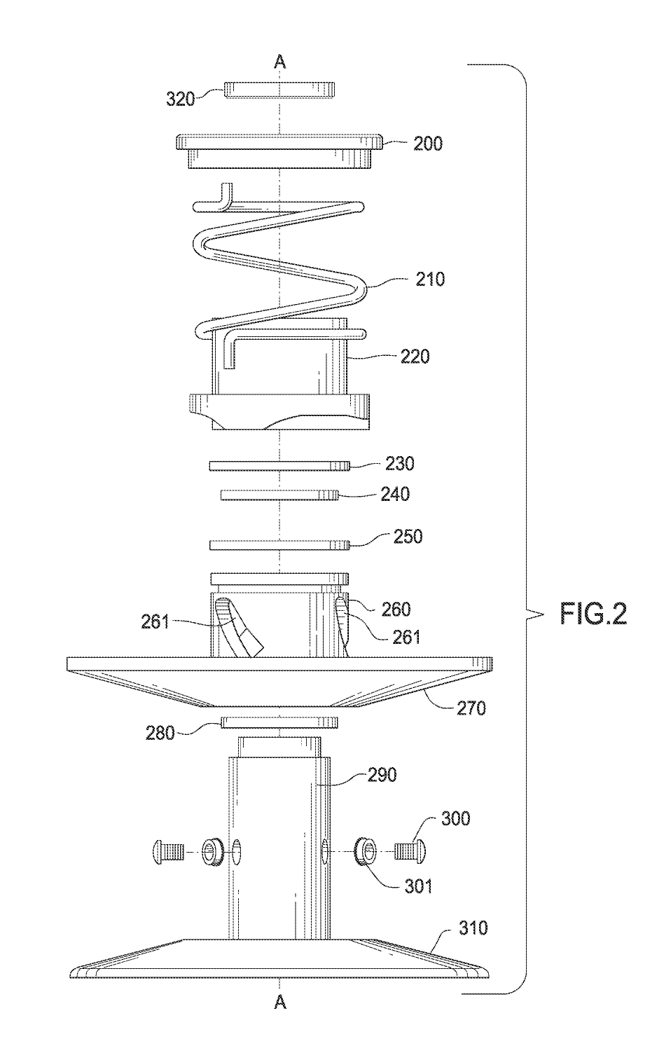

FIG. 2 is an exploded view of the driven clutch mechanism. The driven clutch mechanism comprises spring base 200 attached to shaft 290 by nut 320. Spring 210 is disposed between spring base 200 and spring base 220. O-ring 230 and o-ring 250 seal shaft 290. Oil seal 240 and oil seal 280 seal against shaft 290. Sheave 270 is axially moveable along shaft 290 with respect to sheave 310. Sheave 310 is fixedly attached to shaft 290. Guide members 300 radially extend from and are attached to shaft 290.

Sheave collar 260 is attached to sheave 270. Sheave collar 260 comprises one or more helically shaped slots 261 which partially wrap about collar 260. Each slot 261 extends in an axial direction parallel to axis A-A. Each guide member 300 either rollingly or slidingly engages a slot 261. Engagement of the guide member 300 with a slot 261 prevents rotation of sheave 270 with respect to sheave 310 during operation, although the helical form of slot 261 allows some small amount of relative rotational movement.

Guide member 300 provides at least two functions. First, it provides for the capability to transfer the belt “pull” force from sheaves 270 and 310 to the output shaft 290. Each member 300 also serves as the reaction point to load sensing feedback from slot 261 in the moveable sheave 270. Slot 261 is also called the torque reactive ramp, which converts the driven torque into the axial force which moves the moveable sheave 270 in response to a torque change.

Guide 300 further comprises an outer roller portion 301 which facilitates movement of the guide 300 within slot 261. Nut 320 holds the driven clutch assembly together.

FIG. 3 is a cross-section detail of the driver mechanism. At engine idle there is an initial gap (G) between a belt 400 and moveable sheave 50. Gap (G) prevents the belt from transmitting power since it is not “pinched” between sheave 50 and sheave 100. A space “S” is formed between each member 20 and surface 51 or surface 11 when each member 20 is in its most radially inward position.

FIG. 4 is a cross section of the driver mechanism in the open position. Sheave 50 comprises arcuate ramp surfaces 51. Each surface 51 radially extends from shaft 30. Back plate 10 also comprises ramp surfaces 11, see FIG. 3, which are cooperatively disposed with a surface 51. Each surface 11 radially extends from shaft 30. Each member 20 moves between a surface 11 and a surface 51, which movement causes sheave 50 to move axially along shaft 30 toward or away from sheave 100.

In the disclosed embodiment surface 11 has a planar profile and surface 51 has an arcuate profile. Each profile regulates the rate and radial extent of the movement of each member 20 as it moves radially inward and outward during engine operation. Each surface profile may be adjusted as needed to accommodate the desired rotational characteristic of the clutch.

For example, the profile of surface 11 and surface 51 will affect the radially inward and outward movement of each member 20 as the clutch speed varies. Namely, depending upon the profile each member may have to “climb” up the surface 51 and surface 11 as it moves radially outward, which in turn will affect the rate at which sheave 50 moves toward sheave 100, or, will affect the speed at which each member 20 will be disposed at a desired radial position, which will correspond to a given gear ratio. One skilled in the art can appreciate that selection of a surface 11 and surface 51 profile can be used to affect clutch behavior over a desired speed range.

By way of example and not of limitation, the profile of surface 51 can be arcuate, parabolic, planar, a circular section and so on. In the case of a planar section the angle at which the plane is disposed to a normal radially extending from the shaft axis A-A can be used to affect the rate or speed at which the members 20 will move radially outward during operation. The profile of surface 11 can be arcuate, parabolic, planar, a circular section and so on. In the case of a planar section the angle at which the plane is disposed to a normal radially extending from the shaft axis A-A can be used to affect the rate or speed at which the members will move radially outward during operation.

In the open position each member 20 is disposed in a more radially inward position between back plate 10 and sheave 50. In the radially inward position a space (S) exists such that member 20 is not fixedly captured between back plate 10 and sheave 50 and surface 53 because each member 20 does not simultaneously contact surface 11, surface 51 and surface 53. Members 20 do not necessarily roll along the surface 51 or surface 11. Instead, a member 20 may also slide against surface 51 and surface 11, or a member may slide against one surface and roll across the other. In order to prevent a flat spot developing on the member 20 due to friction or abrasion, a relief shoulder 12 prevents pinching of the member by surface 51 and surface 11.

In the fully open sheave condition the spring 70 force is prevented from being applied to each member 20 by sheave 50 and sheave 100 by a relief shoulder 12, as shown in FIG. 4. Relief shoulder 12 permits a small space (S) between member 20 and surface 51 and surface 11 in the radially inward position. Space (S) allows each member 20 to freely rotate each time member 20 comes back to the initial position, i.e., radially inward, see FIG. 3. This prevents the same spot on each member 20 from repeatedly sliding or rolling against surface 51 and/or surface 11.

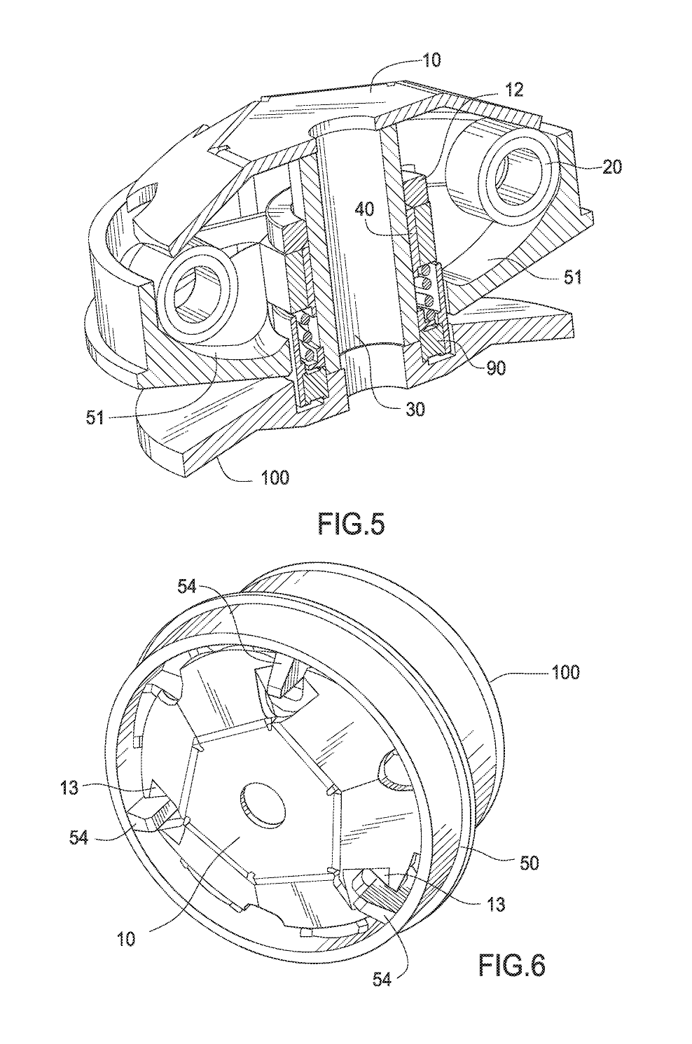

FIG. 5 is a cross section of the driver mechanism in the closed position. In this position the clutch is rotating. In the fully closed position each member 20 is disposed in its most radially outward position between back plate 10 and sheave 50. “Closed” refers to the close relationship of the moveable sheave 50 to fixed sheave 100. Centrifugal force causes each member 20 to move radially outward, thereby urging moveable sheave 50 axially toward sheave 100 along shaft 30. The spacing between sheave 50 and sheave 100 is a function of the radial position of members 20, which is in turn dependent upon the rotational speed of the clutch. In this condition the belt is disposed in its most radially outward position.

Two methods are available to achieve the fully closed position for the sheaves: displacement control and force control. FIG. 5 describes force control. Sheave 50 comprises two surfaces having profiles, namely, surface 51 and surface 52. Surface 51 is described elsewhere in this specification. Surface 52 is typically a cylindrical surface extending parallel to the rotational axis A-A. Surface 52 is tangent to surface 51. When a member 20 contacts surface 52, the centrifugal force is balanced by a reaction force that is 100% in the radial direction, that is, normal to the axis of rotation A-A. This stops the radially outward movement of each member 20. Member 20 contacts surface 11, surface 51 and surface 52 simultaneously, hence, no axial force component is developed to axially move sheave 50. In this condition there is no driving force available to close the sheaves.

In the alternative by extending surface 51 and back plate surface 11 radially outward, thereby preventing a member 20 from contacting flat surface 52, sheave 50 axially moves until it contacts stationary sheave 100. This is the limit of axial movement of sheave 50 and is called displacement control. Displacement control has an advantage over the force control since it allows one to extend the range of the speed ratio change, which can improve the top end speed of a vehicle using the inventive system.

FIG. 6 is a rear view of the driver mechanism. Back plate 10 captures members 20 against sheave 50. Sheave 50 rotates with back plate 10 due to the engagement of each member 54 with a cooperating slot 13. Back plate 10 rotates with shaft 30.

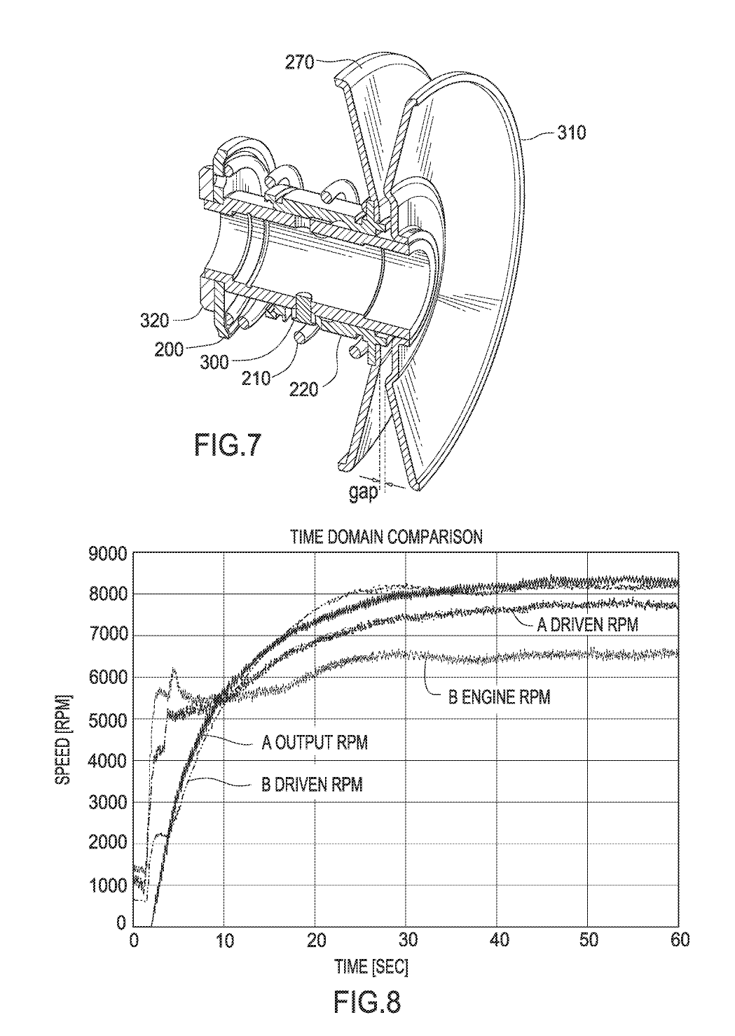

FIG. 7 is a cross section of the driven mechanism. The driven mechanism is shown in the closed position with sheave 270 adjacent to sheave 310.

In operation, instead of using a known centrifugal clutch which is typically placed at the driven clutch assembly position to engage and dis-engage the engine at the idle speed, in the instant clutch the CVT belt is used as the clutching mechanism. Advantages of using a belt clutch include cost savings and improved fuel economy.

In particular, the belt used in the inventive clutch is typically shorter than a belt for a known centrifugal clutch system. Use of a shorter belt forces the driven clutch open slightly, that is, sheave 270 and sheave 310 are forced slightly apart. An initial tension on the belt is developed by spring 210 in FIG. 2. For example, in the instant system a gap (“gap”) of 3.19 mm between the driven sheaves (270, 310) is developed by selecting a belt length of 775 mm, see FIG. 3. The initial gap (“gap”) is a function of the belt's physical engagement between sheaves 270 and 310 which forces sheaves 270 and 310 axially apart against spring 210.

During engine idle the CVT belt 400 is resting on the sleeve 60 and driver bearing 90, see FIG. 3. The initial belt tension is achieved by the combination of a shorter belt, the driven clutch initial gap (gap), and the belt resting on the driver clutch bearing sleeve 60. The initial belt tension causes a smooth transition from the vehicle full stop condition to motion. For example, a prior art snowmobile CVT clutch will typically use a comparatively longer belt in the belt clutch, for example 780 mm compared to 775 mm. There will be no initial belt tension in the prior art system at idle. Since there is no initial tension developed in the belt in the prior art system, the moment the sheaves engage the belt the belt tension will surge. This can cause a jerking engagement at motion start. The jerking engagement is eliminated by the initial belt tension in the inventive system.

The initial gap (“gap”) at the driven clutch, as shown in FIG. 3, also helps to maintain the initial tension even as the belt wears. Typical CVT belt wear can be indicated by a reduction in belt width. In the prior art a belt would otherwise progressively seat radially inward as the belt width gradually reduced over time. However, with an initial gap (“gap”) caused by the belt resisting the spring force, the belt will still seat on sleeve 60 in the same radial position as belt wear progresses, which improves the belt life.

Spring 70 at the driver clutch is used to control the engine belt engagement speed. The greater the compressive spring rate for spring 70, the higher the engine speed required to overcome the spring force and thereby cause sheave 50 to move toward sheave 100, and thereby engage the belt.

Referring to FIG. 3, a CVT belt rests on bearing sleeve 60 during idle. In doing so gap (G) is created between the belt and moveable sheave 50. Shoulder 101 at the fixed sheave 100 supports the bearing 90 inner raceway 92. Spring cup 80 rests upon bearing 90 inner raceway opposite shoulder 101. Spring 70 is disposed between the spring cup 80 and moveable sheave 50. Shoulder 61 on sleeve 60 rests against the bearing 90 outer raceway 91. Recess cut 102 in sheave 100 prevents contact between sheave 100 and sleeve 60.

At engine idle the belt rests against sleeve 60 while spring 70 rotates together with the driver sheave 50. Given gap (G) the belt is not rotating. As the engine rotational speed increases centrifugal force is developed for each member 20 according to the mass of each member. The centrifugal force urges each member 20 radially outward along surface 11 and surface 51, which force has a component oriented axially along shaft 30. This urges moveable sheave 50 closer to the belt and to sheave 100. As the engine speed exceeds the engagement speed, moveable sheave 50 and sheave 100 engage, or “pinch”, the belt. The rotary motion and torque of the engine are then transmitted by the belt from the driver clutch to the driven clutch. Since the belt is pre-tensioned by the engagement of the driven mechanism there is no jerk motion when the driver sheave engages the belt. The engine engagement speed can be tuned by changing the compressive spring rate of spring 70, or by changing the magnitude of the mass of each member 20.

The inventive system achieves smooth engagement transition on engine acceleration. Faster acceleration can also be achieved because the belt slips much less than a prior art centrifugal clutch after the engagement of the belt. The engagement characteristic can also be established based upon the mass and number of each roller. It is also a function of the profile of the radially extending surface and surface 11. For example, a steeper profile for surface 11 and surface 51 will require greater centrifugal force to move the members radially outward, and vice versa.

During a downshift, i.e., the CVT drive shifts from the over drive condition (low speed ratio) to the under drive condition (high speed ratio), it is preferable that the engine remains constantly engaged with the vehicle driveline to take advantage of the engine braking effect. Engine braking is achieved in the inventive system by selecting a proper compression spring 70 pre-load in the driver clutch. In the inventive system an exemplary spring pre-load is 100N. For example, if the pre-load of spring 70 is too high, the driver clutch will open prematurely as the engine speed slows down. If both the driven clutch and driver clutch open simultaneously the belt can lose engagement with the driver and driven clutches and thereby lose tension. This will allow the belt to slip. This in turn can dis-engage the engine losing engine braking which may lead to a runaway situation. On the other hand, if the pre-load of spring 70 is properly selected to maintain the gap (G) during engine idle, the driver clutch will not open prematurely as the engine speed drops from the drive condition. Instead, the driven clutch sheaves will not prematurely move apart thereby holding the belt engaged in a radially outward position. The belt can then press radially inward to force open the driver clutch sheaves during a downshift. Hence, belt tension is maintained during a downshift to allow the CVT to fully utilize engine braking.

FIG. 8 is a chart of the shift curve in time domain. The curve compares a prior art system to the inventive system. It compares output RPM and engine RPM. The inventive system is referred to as “A” and the prior art system as “B”. The inventive system provides quicker acceleration while also providing smooth performance across the entire engine speed range.

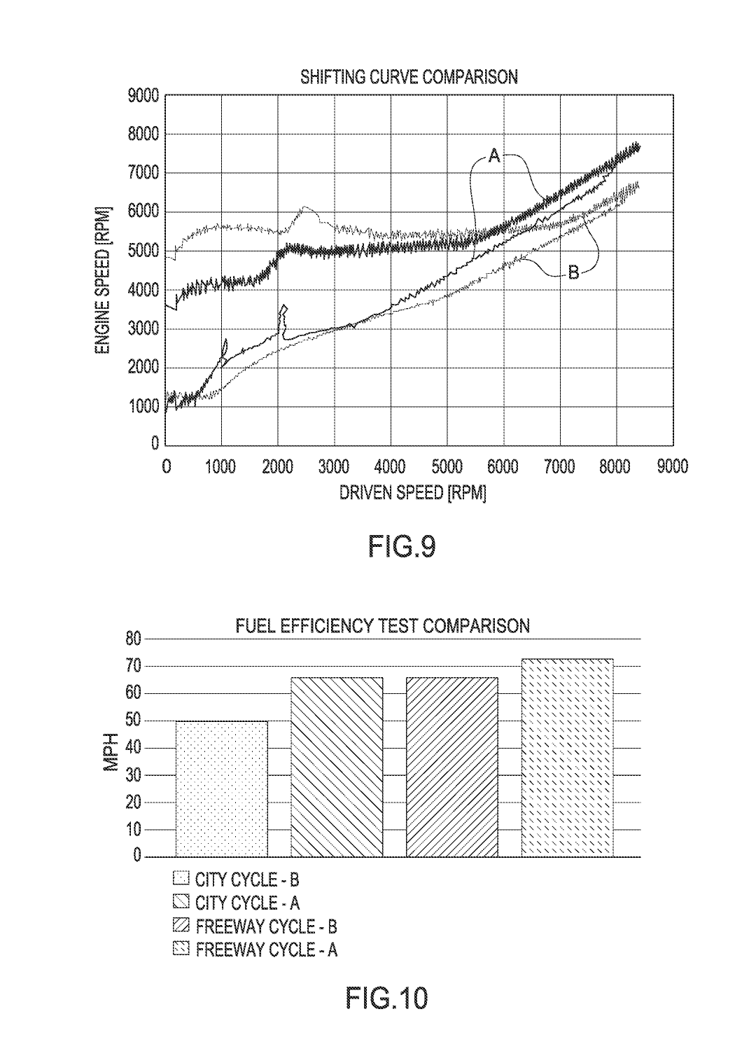

FIG. 9 is a chart of the shift curve at WOT. The inventive system provides smooth engagement performance for wide open throttle (WOT). The inventive system is referred to as “A” and the prior art system as “B”. The inventive system also demonstrates better engine performance across the engine speed range when compared to a prior art system.

FIG. 10 is a fuel efficiency chart. The inventive system is referred to as “A” and the prior art system as “B”. The chart demonstrates that the inventive system provides 32% higher mileage for the city cycle and 11% higher mileage for the highway cycle when compared to a prior art system. Each of these represents a significant improvement in mileage performance for a CVT engine system.

A driving cycle from India is used for the test. The test is different from that used in other countries because initial vehicle cost and fuel economy are the highest priorities, and the engine size for the majority of vehicles is under 125 cc. The test comprises the following parameters.

| | | | | | | | | | | Cruise |
|---|---|---|---|---|---|---|---|---|---|---|
| | | | Avg. | | Max | | Idle time | Accel. | Decal time | time |
| | Time | Distance | Speed | Max. Speed | accel. | Max Decel | ratio | Time ratio | ratio | ratio |
| | sec | km | km/h | km/h | m/s² | m/s² | % | % | % | % |
| IDC | 648 | 3.948 | 21.93 | 42 | 0.65 | 0.63 | 14.81 | 38.89 | 34.26 | 12.04 |
| (6 Cycles) | | | | | | | | | | |

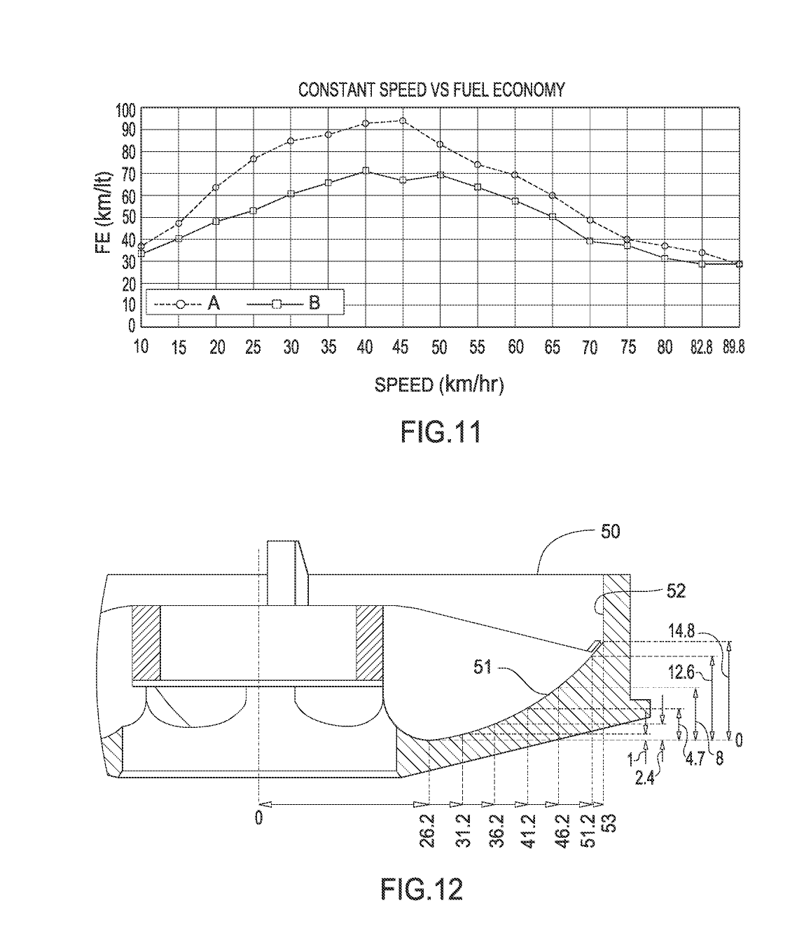

FIG. 11 is a chart which compares constant speed fuel economy for an inventive CVT system and a prior art CVT with centrifugal clutch. The inventive system is referred to as “A” and the prior art system as “B”.

The fuel economy test was conducted on a chassis dynamometer. A scooter equipped with a prior art CVT clutch was tested, namely, prior art system “B”. The same scooter was then tested using the inventive CVT clutch as described in this specification as inventive system “A”. The same engine and fuel were used for both tests.

At all tested speeds the constant speed fuel economy of the inventive CVT system “A” is significantly greater than the prior art centrifugal clutch system “B”. The fuel economy improvement ranges from 11% at the upper and lower speed points up to 32% for 45 km/hr.

FIG. 12 is a cross section of the moveable sheave. Sheave 50 comprises surface 51 upon which a member 20 rolls. FIG. 12 shows an example profile of surface 51. The dimensions are with respect to a “0” point on the axis of rotation and at the base of surface 51. The numeric values in FIG. 12 do not limit the scope of the invention and are simply offered as examples. The profile of surface 51 may be specified in any form which allows members 20 to move to accommodate the operational requirements of the transmission. The profile may comprise a circular section, parabolic section, elliptical section, a planar section or a combination of these sections.

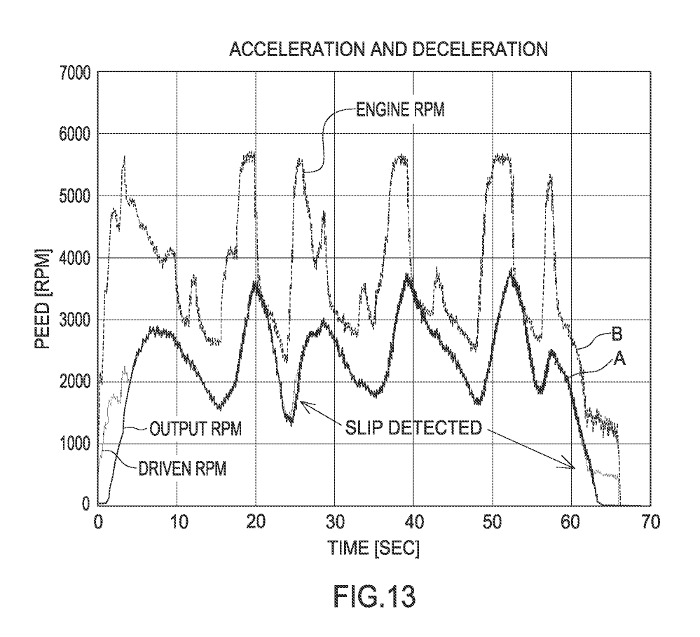

FIG. 13 is a chart depicting belt slip. Improved fuel economy is achieved by overcoming two flaws of a prior art centrifugal clutch. Assuming the prior art centrifugal clutch is placed at the driven clutch, and as the CVT drive is initialized in the under drive condition, a much higher engine speed, typically approximately 3500 RPM of the scooter engine is required in order to engage a typical prior art centrifugal clutch, see curve “B” of FIG. 13.

On the other hand, the inventive system achieves a much lower engagement engine speed in the range of approximately 2000 RPM, see curve “A” of FIG. 13. During rapid engine acceleration and deceleration a prolonged period of drive slip is detected in the prior art centrifugal clutch engagement and dis-engagement, as shown in FIG. 13. However, by placing the inventive belt clutch at the engine shaft, or high-speed shaft, the system slip time duration is significantly reduced. Reduction of drive slip improves fuel economy and improves belt longevity.

Although a form of the invention has been described herein, it will be obvious to those skilled in the art that variations may be made in the construction and relation of parts without departing from the spirit and scope of the invention described herein.

We claim:

1. A CVT drive system comprising:
a moveable sheave axially moveable along a first shaft and having a radially extending surface;
a fixed sheave fixed to the first shaft, the fixed sheave cooperatively disposed with the moveable sheave to engage a belt therebetween, the first shaft engagable with an engine output;
a back plate attached to the first shaft and having a radial surface, the back plate engaged with the moveable sheave for a locked rotation while allowing a relative axial movement;
an inertia member radially moveable upon the radially extending surface and the radial surface upon rotation of the moveable sheave, the inertia member is temporarily disengagable from the radial surface and from the radially extending surface;
a first spring resisting axial movement of the moveable sheave toward the fixed sheave along the first shaft; and
a sleeve member disposed between the moveable sheave and the fixed sheave, the sleeve member rotatable with the belt.

2. The CVT drive system as in claim 1, wherein the radially extending surface has an arcuate profile.

3. The CVT drive system as in claim 1, wherein the inertia member comprises an adjustable mass.

4. The CVT drive system as in claim 1 further comprising a driven clutch which comprises:
a first sheave fixed to a rotatable second shaft;
a second sheave engaged with the second shaft for axial movement along the second shaft;
a second spring urging the first sheave axially away from the second sheave;
the first sheave comprising a member having a helical slot, the helical slot engagable with a member, the member fixed to the second shaft; and
a belt engaged between the driver clutch and the driven clutch.

5. The CVT drive system as in claim 1, wherein a force of the first spring during an engine idle condition retains the moveable sheave in a predetermined position with respect to the fixed sheave such that a gap (G) is maintained between the moveable sheave and the belt or between the fixed sheave and the belt.

6. The CVT drive system as in claim 4, wherein in an engine idle condition the belt engages the sleeve member and the belt has a predetermined preload.

7. A CVT drive system comprising:
a driver clutch comprising:
a moveable sheave axially moveable along a first shaft and having a radially extending surface;
a fixed sheave fixed to the first shaft, the fixed sheave cooperatively disposed with the moveable sheave to engage a belt therebetween, the first shaft engagable with an engine output;
a back plate attached to the first shaft and having a radial surface, the back plate engaged with the moveable sheave for a locked rotation while allowing a relative axial movement;
an inertia member radially moveable upon the radially extending surface and the radial surface upon rotation of the moveable sheave, the inertia member is temporarily disengagable from the radial surface and from the radially extending surface;
a first spring resisting axial movement of the moveable sheave toward the fixed sheave along the first shaft;
a sleeve member disposed between the moveable sheave and the fixed sheave, the sleeve member rotatable with the belt; and
a driven clutch comprising:
a first sheave fixed to a rotatable second shaft;
a second sheave engaged with the second shaft for axial movement along the second shaft;
a second spring urging the first sheave axially away from the second sheave;
the first sheave comprising a member having a helical slot, the helical slot engagable with a member, the member fixed to the second shaft; and
the belt engaged between the driver clutch and the driven clutch.

8. The CVT drive system as in claim 7, wherein a force of the first spring during an engine idle condition retains the moveable sheave in a predetermined position with respect to the fixed sheave such that a gap (G) is maintained between the moveable sheave and the belt.

9. The CVT drive system as in claim 7, wherein in an engine idle condition the belt engages the sleeve member and the belt has a predetermined preload.
